(19) United States
(12) Patent Application Publication
(10) Pub. No.: US 2010/0100643 A1
(43) Pub. Date: Apr. 22, 2010

(54) MULTIMEDIA SYSTEM BY USING EXTERNAL CONNECTION APPARATUS AND EXTERNAL CONNECTION APPARATUS THEREFOR

(75) Inventors: WOOK SHIM, Seoul (KR); INSEONG HWANG, Seoul (KR); HOOJONG KIM, Seoul (KR)

Correspondence Address: David A. Einhorn, Esq.;Baker & Hostetler LLP, 45 Rockefeller Plaza, New York, NY, 10111, US

(73) Assignee: SK TELECOM CO., LTD., Seoul (KR)

(21) Appl. No.: 12/609,663

(22) Filed: Oct. 30, 2009

Related U.S. Application Data
(63) Continuation of application No. PCT/KR2008/002491, filed on May 2, 2008.

(30) Foreign Application Priority Data
May 2, 2007 (KR) 10-2007-0042586

(51) Int. Cl. G06F 3/00

(52) U.S. Cl. 710/1

(57) ABSTRACT

Disclosed is a multimedia system using a mobile communication terminal and an external connection device for the same. The multimedia system uses a video/audio output device, a peripheral device, and an external connection device. The multimedia system includes a mobile communication terminal having a video/audio output function and a peripheral device control function so that the mobile communication terminal outputs images and sounds by using the video/audio output device and controls the peripheral device; and an external connection device for connecting the mobile communication terminal to the video/audio output device and the peripheral device, relaying the images and sounds from the mobile communication terminal to the video/audio output device, and relaying data transmitted/received between the mobile communication terminal and the peripheral device. When multimedia data is reproduced by using a mobile communication terminal, it is easily connected to an external video/audio output device (e.g. a TV) or a peripheral device (e.g. a computer, a mouse, a joystick) to construct a multimedia system.

### TECHNICAL FIELD

The present invention relates to a multimedia system using a mobile communication terminal and an external connection device for the same. More particularly, the present invention relates to a multimedia system including a mobile communication terminal, which incorporates various multimedia functions (a video/audio output function, a peripheral device control function, etc.), an external connection device for connecting the mobile communication terminal to a video/audio output device or a peripheral device, and a remote control device for controlling the mobile communication terminal at a distance so that various multimedia environments can be provided by using the mobile communication terminal, as well as an external connection device for the same.

### BACKGROUND ART

As generally known in the art, development of electronic communication technology is followed by commercialization and widespread use of mobile communication technology. Consequently, mobile communication terminals (e.g. cellular phones, personal portable terminals, etc.) have become daily necessities of modern people.

Mobile communication terminals have been developed for voice communication and data communication on the move. Mobile communication terminals are becoming smaller and lighter to maximize mobility. However, although compact mobile communication terminals are convenient to carry and use on the move, they cannot fully realize multimedia functions (e.g. using wireless Internet, photography, playing music, playing moving pictures, enjoying games), which are basically incorporated recently, due to the small screen size.

In other words, mobile communication terminals having small screens cannot output the entire web pages via the wireless Internet, and users cannot fully enjoy moving pictures and games due to the small screens.

In addition, compact mobile communication terminals use a very small interface (e.g. keypad) as the input means for receiving the user's input of commands or data. Therefore, they are inconvenient to operate when complicated input operations are necessary (e.g. games). This also makes it difficult to take full advantage of multimedia functions (e.g. mobile games).

In an attempt to solve these problems, it has been proposed to output images and sounds via external devices (e.g. TVs) instead of reproducing them by mobile communication terminals. Furthermore, various convenient input means (e.g. a mouse, a keyboard, a joystick) may be directly connected to mobile communication terminals so that users can input commands or data by them. It has also been tried to connect various external storage devices (e.g. a hard disk, an external memory) to mobile communication terminals to compensate for their insufficient memory.

In order to connect mobile communication terminals to external devices directly, however, they must be provided with an interface. Since mobile communication terminals are becoming more compact, it is difficult to make room for adding an interface for connecting to external devices. Even if an interface has been added and connected to external devices, the direct connection between a number of external devices and the mobile communication terminal complicates the wiring, and it is inconvenient to connect/disconnect lines for each connecting operation.

Assuming that a number of external devices have been connected to a mobile communication terminal and that the user is enjoying a game by outputting data inside the terminal to external devices or receiving inputted data or commands, he/she is supposed to operate the terminal while watching images and sounds outputted by the external devices. In such a case, the user may be at a distance from the mobile communication terminal, and then he/she must approach and operate the terminal every time the terminal needs to be operated.

In order to avoid such inconveniences, recent mobile communication terminals are equipped with an IR communication module so that the terminals can be controlled by using a remote control device (e.g. remote control system). However, this approach has a problem in that, since the IR port is positioned on a portion of mobile communication terminals (e.g. upper, lower, left, right, or front portion), remote control is impossible unless the remote control device faces the IR port within a predetermined angular range. This means that the IR port of mobile communication terminals must be moved every time remote control is conducted.

Furthermore, mobile communication terminals equipped with an IR communication module must always prepare to receive IR signals via the IR communication module. This increases power consumption, reduces the battery's standby time, and degrades user convenience.

### DISCLOSURE

### Technical Solution

Therefore, the present invention has been made in view of the above-mentioned problems, and the present invention provides a multimedia system including a mobile communication terminal, which incorporates various multimedia functions (a video/audio output function, a peripheral device control function, etc.), an external connection device for connecting the mobile communication terminal to a video/audio output device or a peripheral device, and a remote control device for controlling the mobile communication terminal at a distance so that various multimedia environments can be provided by using the mobile communication terminal, as well as an external connection device for the same.

In accordance with an aspect of the present invention, there is provided a multimedia system using a video/audio output device, a peripheral device, and an external connection device, the multimedia system including a mobile communication terminal having a video/audio output function and a peripheral device control function so that the mobile communication terminal outputs images and sounds by using the video/audio output device and controls the peripheral device; and an external connection device for connecting the mobile communication terminal to the video/audio output device and the peripheral device, relaying the images and sounds from the mobile communication terminal to the video/audio output device, and relaying data transmitted/received between the mobile communication terminal and the peripheral device.

In accordance with another aspect of the present invention, there is provided an external connection device for connecting a video/audio output device and a peripheral device to a mobile communication terminal in a multimedia system, the external connection device including an input/output port for connecting to the mobile communication terminal; a video/audio port for connecting to the video/audio output device; and a USB connection port for connecting to the peripheral device.

### DESCRIPTION OF DRAWINGS

The foregoing and other objects, features and advantages of the present invention will become more apparent from the following detailed description when taken in conjunction with the accompanying drawings in which:

FIG. 1 is a block diagram briefly showing a multimedia system using a mobile communication terminal according to an exemplary embodiment of the present invention;

FIG. 2 is a block diagram briefly showing the internal construction of an external connection device according to an exemplary embodiment of the present invention;

FIG. 3 is a block diagram briefly showing the internal construction of a mobile communication terminal according to an exemplary embodiment of the present invention; and

FIG. 4 shows an example of implementing a multimedia system according to an exemplary embodiment of the present invention.

### MODE FOR INVENTION

Hereinafter, exemplary embodiments of the present invention will be described with reference to the accompanying drawings. In the following description and drawings, the same reference numerals are used to designate the same or similar components, and so repetition of the description on the same or similar components will be omitted. Furthermore, a detailed description of known functions and configurations incorporated herein is omitted to avoid making the subject matter of the present invention unclear.

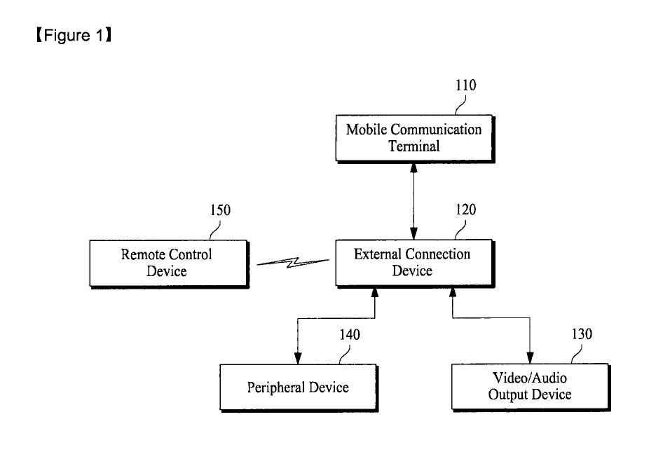

FIG. 1 is a block diagram briefly showing a multimedia system using a mobile communication terminal according to an exemplary embodiment of the present invention.

The multimedia system using a mobile communication terminal according to an exemplary embodiment of the present invention includes a mobile communication terminal 110, an external connection device 120, a video/audio output device 130, a peripheral device 140, and a remote control device 150.

The mobile communication terminal 110 is a portable terminal for providing a voice communication service or a wireless data service by means of mobile communication, reproducing multimedia data (e.g. images, moving pictures, music) downloaded and stored, and providing games by using a wireless data service. The mobile communication terminal may be a cellular phone, a PDA (Personal Digital Assistant), a PMP (Portable Multimedia Player), or a PSP (Play Station Portable).

The mobile communication terminal 110 according to an exemplary embodiment of the present invention has a video/audio output function and a peripheral device control function. Particularly, the mobile communication terminal 110 extracts video and audio signals from multimedia data and transmits them to the video/audio output device 130 via the external connection device 120 so that the video/audio output device 130 outputs images and sounds. The mobile communication terminal 110 conducts data communication with the peripheral device 140 via the external connection device 120 and controls the peripheral device 140.

The mobile communication terminal 110 according to an exemplary embodiment of the present invention also has a remote control function so that, when a remote control signal is received from the remote control device 150 via the external connection device 120, additional functions (e.g. a channel switching function, a volume adjustment function, etc.) are controlled according to the remote control signal.

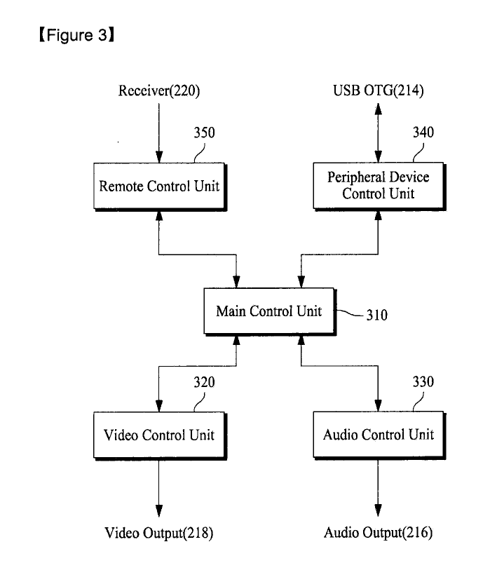

The internal construction of the mobile communication terminal 110 according to an exemplary embodiment of the present invention will be described later in more detail with reference to FIG. 3.

The external connection device 120 according to an exemplary embodiment of the present invention is implemented as a cellular phone cradle so that the mobile communication terminal 110 is cradled thereon. The external connection device 120 connects the mobile communication terminal 110 to the video/audio output device 130 and the peripheral device 140 to transmit video and audio signals from the mobile communication terminal 110 to the video/audio output device 130 and relay data between the mobile communication terminal 110 and the peripheral device 140. The external connection device 120 also receives remote control signals from the remote control device 150 and relays them to the mobile communication terminal 110.

The external connection device 120 according to an exemplary embodiment of the present invention has a video filter function and an audio filter function so that, when video and audio signals are received from the mobile communication terminal 110, the video and audio signals are filtered and transmitted to the video/audio output device 130, respectively.

The external connection device 120 according to an exemplary embodiment of the present invention supplies external power to the mobile communication terminal 110, the peripheral device 140, and the video and audio filters of the external connection device 120.

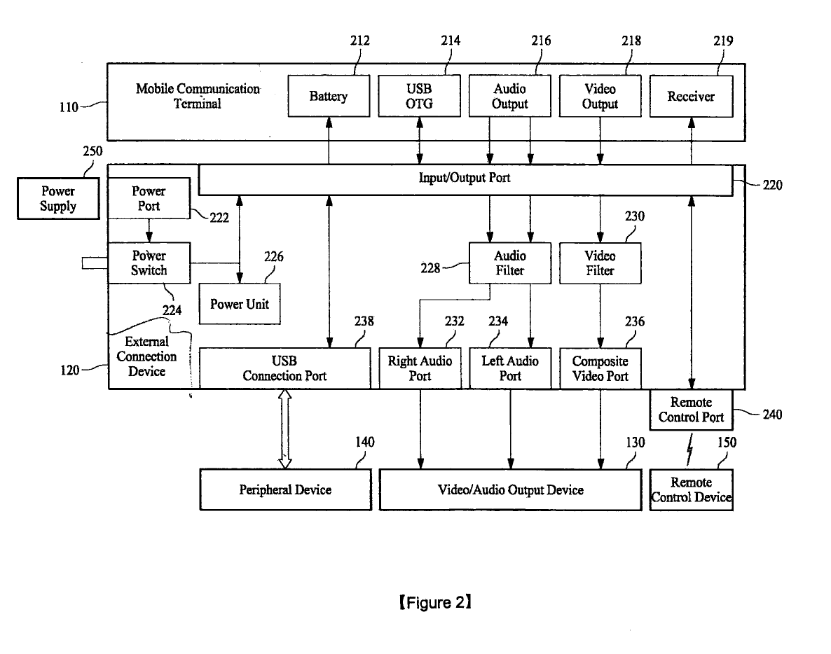

The internal construction of the external connection device 120 according to an exemplary embodiment of the present invention will be described later in more detail with reference to FIG. 2.

The video/audio output device 130 is an output device capable of outputting large-screen images and sounds, such as a TV. Particularly, the video/audio device 130 receives sky waves and outputs images and sounds. Alternatively, the video/audio output device 130 receives video and audio signals from an external device and outputs the signals to a display device and an audio output device. The video/audio output device 130 has a video port for receiving video signals and right and left audio ports for receiving audio signals, and respective ports are connected to the external connection device 120.

The peripheral device 140 includes various types of peripheral devices, such as a computer, a laptop computer, a joystick, a USB (Universal Serial Bus) memory, and a hard disk. The peripheral device 140 is connected to the mobile communication terminal 110 via the external connection device 120 to exchange data with the mobile communication terminal 110 under the control of the mobile communication terminal 110.

The remote control device 150 is a control device for controlling other devices remotely, such as a remote control system. The remote control device 150 emits IR signals to the IR receiver of the external connection device 120 to control the mobile communication terminal 110 connected to the external connection device 120.

FIG. 2 is a block diagram briefly showing the internal construction of an external connection device according to an exemplary embodiment of the present invention.

The external connection device 120 according to an exemplary embodiment of the present invention includes an input/output port 220, a power port 222, a power switch 224, a power unit 226, an audio filter 228, a video filter 230, a right audio port 232, a left audio port 234, a composite video port 236, a USB connection port 238, and a remote control port 240.

The input/output port 220 is used to connect to the mobile communication terminal 110, and may be implemented as a 24-pin interface. A predetermined number of the 24 pins are used to exchange data with the mobile communication terminal 110.

The following Table 1 shows a 24-pin structure according to an exemplary embodiment of the present invention.

TABLE 1

| 24 Pins | Signal Name | Description |
|---|---|---|
| 1 | Battery ID | Charging |
| 2 | HF_Mode | Signal Below 3.3 V |
| 3 | TV Output | TV Video Connection |
| 4 | Power (2.0~5.5 V) | Charging |
| 5 | Power (2.0~5.5 V) | Charging |
| 6 | On_Switch | For Manufacturer Test Substrate |
| 7 | Key Input | IR Receiving |
| 8 | Left Audio | TV Audio Connection |
| 9 | Right Audio | TV Audio Connection |
| 10 | USB Data | Connect With Peripheral Device |
| 11 | Key Input | IR Receiving |
| 12 | GND | Charging |
| 13 | RXD | Data Communication |
| 14 | TXD | Data Communication |
| 15 | USB Data | Connect With Peripheral Device |
| 16 | USB Power (5.0 V) | Connect With Peripheral Device |
| 17 | DCD | Data Communication |
| 18 | RI | Data Communication |
| 19 | USB Power | Connect With Peripheral Device |
| 20 | RFR | Data Communication |
| 21 | Power (4.2 V) | Mobile Communication Terminal |
| | | Power Supply |
| 22 | Power (4.2 V) | Mobile Communication Terminal |
| | | Power Supply |
| 23 | CTS | Data Communication |
| 24 | DTR | Data Communication |

The 24-pin structure according to an exemplary embodiment of the present invention shown in Table 1 uses pins numbered 1, 2, 4-6, 12-14, 17, 18, and 20-24 of the standard 24-pin interface without modification, but pins numbered 4, 7-11, 15, 16, and 19 are newly defined and used to supply the mobile communication terminal 110 with power and connect the mobile communication terminal 110 with the video/audio output device 130 or connect the mobile communication terminal 110 with the peripheral device 140.

Therefore, the input/output port 220 is connected to the mobile communication terminal 110, particularly to its battery 212, USB OTG (USB On The Go) 214, audio output 216, video output 218, and receiver 219, based on the 24-pin structure shown in FIG. 1. Although it has been assumed that the input/output port 220 is based on the standard 24-pin structure, it is also possible to adopt a 20-pin structure (Korea Telecommunication Technology Association is recently developing a scheme for using 20 pins on the external port of mobile communication terminals).

The power port 222 is connected to an external power supply 250 and transmits the power to the power switch 224.

The power switch 224 either transmits the power from the power port 222 to the input/output port 220 or the power unit 226 or interrupts the power depending on the condition of the switch.

The power unit 226 supplies the USB connection port 238 with power and, if the external connection device 120 has an audio filter 228 and a video filter 230, supplies the audio and video filters 228 and 230 with operating power.

The audio filter 228 filters audio signals, which are received from the mobile communication terminal 110 via the input/output port 220, and transmits the signals to the right and left audio ports 232 and 234.

The video filter 230 filters video signals, which are received from the mobile communication terminal 110 via the input/output port 220, and transmits the signals to the composite video port 236.

The right audio port 232 is connected to the audio port of the video/audio output device 130 to forward right audio signals from the mobile communication terminal 110 to the video/audio output device 130.

The left audio port 234 is connected to the audio port of the video/audio output device 130 to forward left audio signals from the mobile communication terminal 110 to the video/audio output device 130.

The composite video port 236 is connected to the video port of the video/audio output device 130 to forward video signals from the mobile communication terminal 110 to the video/audio output device 130.

The USB connection port 238 is implemented as a USB interface and is connected to the peripheral device 140 to transmit supplied power to the peripheral device 140 or enable data communication between the mobile communication terminal 110 and the peripheral device 140 via the USB interface.

The remote control port 240 consists of an IR receiver, such as an IrDA (Infrared Data Association) receiver sensor, so that, when a remote control signal is received from the remote control device 150, the remote control signal is transmitted to the mobile communication terminal 110 via the input/output port 220.

Although the external connection device 120 according to an exemplary embodiment of the present invention has been described and shown in FIG. 2 to include all of the power port 222, the power switch 224, the power unit 226, the audio filter 228, the video filter 230, and the remote control port 240, the power port 222, the power switch 224, and the power unit 226 may be omitted if the external connection device 120 needs no charging function. In this case, the input/output port 220 and the USB connection port 238 are directly connected.

The audio and video filters 228 and 230 may also be omitted if the external connection device 120 according to an exemplary embodiment of the present invention does not need the audio filter function and the video filter function. In this case, the input/output port 220 is directly connected to the right audio port 232, the left audio port 234, and the composite port 236 via copper wires, for example.

The remote control port 240 may be omitted if the external connection device 120 according to an exemplary embodiment of the present invention needs no IR receiving function. In this case, the remote control port 240 and the input/output port 220 are not connected.

Furthermore, although it has been assumed in FIG. 2 that the external connection device 120 according to an exemplary embodiment of the present invention is connected to the video/audio output device 130 via three ports (i.e. right and left audio ports 232 and 234 and composite video port 236), these ports may be replaced with a single video/audio port, which may be a super-video port or an HDMI (High Definition Multimedia Interface) port.

When the external connection device 120 and the video/audio output device 130 are connected via a super-video port, the audio output 216 and the video output 218 of the mobile communication terminal 110 are adapted to output a left audio signal, a right audio signal, a Y signal, and a color signal, and are connected to four pins of the input/output port 220, which lead to two audio pins and two video pins of the super-video port.

When the external connection device 120 and the video/audio output device 130 are connected via a HDMI port, it is preferable to additionally provide an HDMI encoder (not shown) in the mobile communication terminal 110 and an HDMI decoder (not shown) in the video/audio output device 130. The audio output 216 and the video output 218 of the mobile communication terminal 110 output digital audio and video signals, which are not compressed, combine them into one through the HDMI encoder, and transmit the combined signal to the video/audio output device 130 via the input/output port 220 of the external connection device 120 (e.g. a 40-pin connector including 16 pins obtained by excluding unused or overlapping pins from 19 pins of the HDMI port, and existing 24 pins is used, or a separate HDMI port may be added to the input/output port 220). The video/audio output device 130 uses the HDMI decoder to separate the combined signal into digital audio and video signals and output images and sounds. Particularly, the mobile communication terminal 110 reproduces moving pictures, creates video and audio signals adapted for HDMI output, and transmits the signals to the video/audio output device 130 via the input/output port 220 of the external connection device 120. Then, the video/audio output device 130 receives the video and audio signals adapted for HDMI output via the input/output port 220 of the external output device 120, separates the signals, and reproduces images and sounds.

FIG. 3 is a block diagram briefly showing the internal construction of a mobile communication terminal according to an exemplary embodiment of the present invention.

The mobile communication terminal 110 according to an exemplary embodiment of the present invention includes a main control unit 310, a video control unit 320, an audio control unit 330, a peripheral device control unit 340, and a remote control unit 350. Each component corresponds to a combination of a memory, which stores software for conducting each function, and a microprocessor for executing the software stored in the memory.

The main control unit 310 controls the overall operation of the mobile communication terminal 110.

The video control unit 320 extracts video signals from multimedia data, which is stored, reproduced, or executed by the mobile communication terminal 110, and transmits the extracted video signals to the video/audio output device 130 via the video output 218 and the external connection device 120.

The audio control unit 330 extracts audio signals, which are stored, reproduced, or executed by the mobile communication terminal 110, and transmits the extracted audio signals to the video/audio output device 130 via the audio output 216 and the external connection device 120.

Although it has been assumed in the description with reference to FIG. 3 that the video and audio control units 320 and 330 are separate units for outputting video and audio signals, respectively, they may be implemented as a single module for outputting both video and audio signals when the right and left audio ports 232 and 234 and the the remote control signal, and identifies a control code contained in the remote control signal. The remote control unit 350 recognizes the command corresponding to the control code and transmits it to the main control unit 310 so that the main control unit 310 controls additional functions of the mobile communication terminal 110 according to the remote control signal. The receiver 219 may consist of an input/output device for inputting/outputting digital signals, such as a GPIO (General Purpose Input/Output).

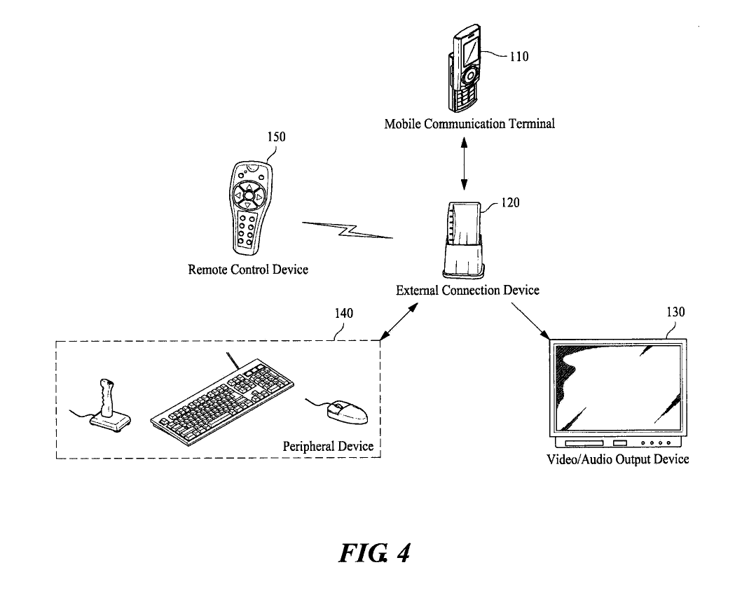

FIG. 4 shows an example of implementing a multimedia system according to an exemplary embodiment of the present invention.

When the user of the mobile communication terminal 110 (e.g. cellular phone) wants to reproduce multimedia data (e.g. moving pictures) stored in the mobile communication terminal 110, he/she inserts the mobile communication terminal 110 into the external connection device 120 (e.g. cradle) and cradles the terminal 110 so that moving pictures are not reproduced by the small screen and speaker of the terminal 110, but by the video/audio output device 130 having a large screen and a high-power speaker (e.g. TV). When cradled on the external connection device 120, the mobile communication terminal 110 is connected via the input/output port 212 of the external connection device 120, which has a 24-pin structure.

The user also connects the external connection device 120 to the video/audio output device 130. Particularly, a S-video cable or a composite video cable is used to connect the video port of the video/audio output device 130 to the composite video port 236 of the external connection device 120, and audio cables are used to connect the audio port of the video/audio output device 130 to the right and left audio ports 232 and 234 of the external connection device 120.

Then, the user operates the mobile communication terminal 110 to reproduce multimedia data (e.g. moving pictures). Video and audio signals are extracted from the moving pictures reproduced by the mobile communication terminal 110 and are transmitted to the video/audio output device 130 via the external connection device 120. The video/audio output device 130 outputs images and sounds.

The user watches images and sounds reproduced by the video/audio output device 130 at a distance for realistic experience. In this case, it may be inconvenient to operate the mobile communication terminal 110, which is cradled on the external connection device 120. Furthermore, the user may want to play games by using the mobile communication terminal 110. In this case, the user connects a peripheral device 140, such as a joystick, a mouse, a keyboard, or a computer, to the external connection device 120 so that he/she can operate the mobile communication terminal 110 by using the peripheral device 140 while the video/audio output device 130 outputs images and sounds. A USB cable may be used to connect the peripheral device 140 to the external connection device 120. Particularly, a USB cable is drawn out of the peripheral device 140 and is connected to the USB connection port 238 of the external connection device 120.

After the connection is made, the user can operate the mobile communication terminal 110 by means of the computer, mouse, keyboard, etc. and watch moving pictures, games, etc., which are reproduced by the mobile communication terminal 110, via the video/audio output device 130 connected to the external connection device 120.

It may be inconvenient to operate the mobile communication terminal 110, which is cradled on the external connection device 120, every time the user wants to adjust the volume or change the playback time while watching images and sounds from the video/audio output device 130. In this case, the user can operate the remote control device 150, i.e. simply press buttons on the remote control device 150, at a distance so that the mobile communication terminal 110 analyzes the remote control signal, which is transmitted from the remote control device 150 via the external connection device 120, and conducts corresponding control. As such, the user can easily control the mobile communication terminal 110 at a distance.

Once the user has connected the video/audio output device 130, the peripheral device 140, etc. to the external connection device 120, he/she can carry and use the mobile communication terminal 110 as desired, and when he/she wants to use the multimedia system, he/she has only to cradle the mobile communication terminal 110 on the external connection device 120. Then, the user can watch images and sounds from the constructed multimedia system while charging the terminal 110.

In other words, according to the present invention, the mobile communication terminal 110 is simply cradled on the external connection device 120 to charge the mobile communication terminal 110 or connect it to the video/audio output device 130 (e.g. TV) and the external device 140, such as a keyboard, a mouse, a joystick, or a PC.

The mobile communication terminal 110 has all the functions of separating video and audio signals, which are to be transmitted to the video/audio output device 130, controlling peripheral devices, analyzing remote control signals received from the remote control device 150, and executing commands based on the control code. Instead, the external connection device 120 is solely adapted to relay signals or data for these functions. This simplifies the internal construction of the external connection device 120, makes its implementation easy, and reduces the cost for implementation.

The mobile communication terminal 110 has no remote control port (e.g. IR receiver), but the external connection device 120 has a remote control port so that the internal circuit is connected only when the mobile communication terminal 110 is connected to the external connection device 120. This reduces power consumed to receive remote control signals and lengthens the battery's standby time. In other words, the receiver 219 and the remote control port 240 make circuit-connection via the input/output port 220 only when the mobile communication terminal 110 is connected to the external connection device 120 to be charged. This reduces power consumption of the mobile communication terminal 110.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As mentioned above, the present invention is advantageous in that, when multimedia data is reproduced by using a mobile communication terminal, it is easily connected to an external video/audio output device (e.g. a TV) or a peripheral device (e.g. a computer, a mouse, a joystick) to construct a multimedia system.

The remote control device is used to control the mobile communication terminal at a distance so that the user can fully enjoy the multimedia system.

The external connection device has simple functionality and construction so that it can be easily implemented at a low cost.

The mobile communication terminal does not always consume power to receive remote control signals from the remote control device. This minimizes power consumption and lengthens the battery's standby time.

1. A multimedia system using a video/audio output device, a peripheral device, and an external connection device, the multimedia system comprising:
a mobile communication terminal having a video/audio output function and a peripheral device control function so that the mobile communication terminal outputs images and sounds by using the video/audio output device and controls the peripheral device; and
an external connection device for connecting the mobile communication terminal to the video/audio output device and the peripheral device, relaying the images and sounds from the mobile communication terminal to the video/audio output device, and relaying data transmitted/received between the mobile communication terminal and the peripheral device.

2. The multimedia system as claimed in claim 1, wherein the external connection device is adapted to transmit external power supply to the mobile communication terminal to charge a battery of the mobile communication terminal.

3. The multimedia system as claimed in claim 1, wherein the external connection deice is a cradle for cradling the mobile communication terminal.

4. The multimedia system as claimed in claim 1, wherein the mobile communication terminal comprises:
a video control unit for extracting a video signal from multimedia data and transmitting the video signal to the video/audio output device by using the external connection device;
an audio control unit for extracting an audio signal from the multimedia data and transmitting the audio signal to the video/audio output device by using the external connection device; and
a peripheral device control unit for controlling the peripheral device by conducting communication with the peripheral device via the external connection device.

5. The multimedia system as claimed in claim 1, wherein the multimedia system further comprises a remote control device for controlling the mobile communication terminal remotely, and the external connection device receives a remote control signal from the remote control device and relays the remote control signal to the mobile communication terminal.

6. The multimedia system as claimed in claim 5, wherein the mobile communication terminal comprises a remote control unit for receiving the remote control signal and controlling an additional function of the mobile communication terminal according to the remote control signal.

7. An external connection device for connecting a video/audio output device and a peripheral device to a mobile communication terminal in a multimedia system, the external connection device comprising:
an input/output port for connecting to the mobile communication terminal;
a video/audio port for connecting to the video/audio output device; and
a USB connection port for connecting to the peripheral device.

8. The external connection device as claimed in claim 7, further comprising:
a power port for receiving external power supply;
a power switch for switching connection of the power supply; and
a power unit for transmitting the power supply to the input/output port and the USB connection port when the power supply is received from the power switch.

9. The external connection device as claimed in claim 7, further comprising:
a video filter for filtering a video signal transmitted via the input/output port and transmitting the video signal to the video/audio port; and
an audio filter for filtering an audio signal transmitted via the input/output port and transmitting the audio signal to the video/audio port.

10. The external connection device as claimed in claim 9, wherein the video/audio port comprises a composite video port, a right audio port, and a left audio port, the video filter is connected to the composite video port, and the audio filter is connected to the right and left audio ports.

11. The external connection device as claimed in claim 7, further comprising a remote control port for receiving a remote control signal from the remote control device and transmitting the remote control signal to the input/output port, the remote control signal being transmitted to the mobile communication terminal via the input/output port.

12. The external connection device as claimed in claim 7, wherein the input/output port is a 24-pin interface.

13. The external connection device as claimed in claim 7, wherein the mobile communication terminal comprises a battery, a USB OTG (Universal Serial Bus On The Go), an audio output, a video output, and a remote control receiver, and is connected to the input/output port.

14. The external connection device as claimed in claim 7, wherein the USB connection port is a USB interface.
